(19) United States
(12) Patent Application Publication
(10) Pub. No.: US 2014/0181989 A1
(43) Pub. Date: Jun. 26, 2014

(54) INFORMATION PROCESSING APPARATUS, COMMUNICATION TERMINAL APPARATUS, AND STORAGE MEDIUM

(71) Applicant: SONY CORPORATION, Tokyo (JP)

(72) Inventors: YOICHIRO SAKO, Tokyo (JP); KAZUNORI HAYASHI, Tokyo (JP); YASUNORI KAMADA, Kanagawa (JP); TAKAYASU KON, Tokyo (JP); KOHEI ASADA, Kanagawa (JP); KAZUYUKI SAKODA, Chiba (JP); TAKATOSHI NAKAMURA, Tokyo (JP); MITSURU TAKEHARA, Tokyo (JP); KAZUHIRO WATANABE, Tokyo (JP); HIROYUKI HANAYA, Kanagawa (JP); TOMOYA ONUMA, Shizuoka (JP); YUKI KOGA, Tokyo (JP); AKIRA TANGE, Tokyo (JP)

(73) Assignee: SONY CORPORATION, Tokyo (JP)

(21) Appl. No.: 14/098,754

(22) Filed: Dec. 6, 2013

(30) Foreign Application Priority Data
Dec. 25, 2012 (JP) 2012-281087

(51) Int. Cl. G06F 21/60; H04W 4/02

(52) U.S. Cl. CPC G06F 21/60; H04W 4/02
USPC 726/26

(57) ABSTRACT

There is provided an information processing apparatus including a storage controller configured to perform control in a manner that a log of a user is stored in a storage, a determination part configured to determine whether a position of the user is within a set area, and an erasure controller configured to substantially erase, when the determination part determines that the position of the user is not within the set area, at least data capable of identifying the user individually among the log of the user stored in the storage.

### CROSS REFERENCE TO RELATED APPLICATIONS

This application claims the benefit of Japanese Priority Patent Application JP 2012-281087 filed Dec. 25, 2012, the entire contents of which are incorporated herein by reference.

### BACKGROUND

The present disclosure relates to an information processing apparatus, a communication terminal apparatus, and a storage medium.

Typically, resort facilities and tourist sites provide various services, such as offering of guidance information and photograph taking.

For example, JP 2004-258872A discloses a guidance information-providing service providing guidance information of a theme park, the guidance information being optimally personalized for an individual based on personal information collected and possessed by a network provider or a sensing provider. Further, JP 2004-258872A also discloses that the guidance information-providing service is preferably used in facilities such as an amusement park, a baseball stadium, a large-scale department store, and a shopping mall, in addition to the theme park.

Here, in order to receive information personalized for an individual based on personal information, user registration in advance is necessary. However, entering his/her own name at the time of user registration is a matter that largely concerns a privacy of the user, and hence, the user considers refraining from entering his/her name.

In contrast, JP 2011-221584A discloses an anonymous ID management system which manages, in a pair, a nickname and identification information of a non-contact information medium, the nickname serving as an anonymous ID different from a real name serving as personal information, and allows a user to participate in life activities and economic activities through the use of the non-contact information medium. The anonymous ID management system is installed particularly in facilities such as a shopping mall, a department store, a complex facility, an exhibition hall, an exhibition site, an amusement park, and an entertainment facility, and manages an admission of the user into a facility, product purchase information within the facility, and the like while maintaining the user's anonymity.

### SUMMARY

However, in the technology described in JP 2004-258872A, the user can receive the guidance information-providing service corresponding to the personal information in a facility, but after the user has left the facility, the service still holds the personal information and uses the personal information as data for analysis/statistics even though the user cannot receive the service any more. Further, JP 2004-258872A suggests nothing about changing handling of the personal information of the user in the case where the user leaves the facility.

Further, in JP 2011-221584A, the user can avoid entering the real name by participating in life activities and economic activities by using the nickname serving as the anonymous ID different from the real name, but there may be a case where the user does not want to let an acquaintance know the nickname in everyday life. Further, in particular, it is not desirable for the user that the nickname that is used in a facility such as a theme park or an amusement park, where the user can experience things that are completely different from his/her everyday life, is managed in a pair with a facial image registered in the facility or a photograph taken in the facility, and is continuingly held as user information.

In light of the foregoing, the present disclosure provides an information processing apparatus, a communication terminal apparatus, and a storage medium, which are novel and improved, and which can perform a predetermined control such that, when the user leaves an area, it is made not possible to identify the log of the user during the stay in the area.

According to an embodiment of the present disclosure, there is provided an information processing apparatus which includes a storage controller configured to perform control in a manner that a log of a user is stored in a storage, a determination part configured to determine whether a position of the user is within a set area, and an erasure controller configured to substantially erase, when the determination part determines that the position of the user is not within the set area, at least data capable of identifying the user individually among the log of the user stored in the storage.

According to another embodiment of the present disclosure, there is provided a communication terminal apparatus which includes a detector configured to detect position information related to a current position of a communication terminal apparatus, a determination part configured to determine whether a position indicated by the detected position information is within a set area, and a transmission controller configured to control a transmitter in a manner that, when the determination part determines that the position indicated by the position information is not within the set area, a control signal is transmitted to an information processing apparatus, the control signal issuing an instruction to erase at least data capable of identifying a user individually among a log of the user accumulated in the information processing apparatus.

According to another embodiment of the present disclosure, there is provided an information processing apparatus which includes a storage controller configured to perform control in a manner that a log of a user is stored in a storage, a receiver configured to receive a control signal issuing an instruction to erase at least data capable of identifying the user individually among the log of the user, the control signal being transmitted from a communication terminal apparatus because a position of the communication terminal apparatus is determined not within a set area, and an erasure controller configured to substantially erase the data capable of identifying the individual user among the log of the user stored in the storage in accordance with the received control signal.

According to another embodiment of the present disclosure, there is provided a non-transitory computer-readable storage medium having a program stored therein, the program causing a computer to function as a storage controller configured to perform control in a manner that a log of a user is stored in a storage, a determination part configured to determine whether a position of the user is within a set area, and an erasure controller configured to substantially erase, when the determination part determines that the position of the user is not within the set area, at least data capable of identifying the user individually among the log of the user stored in the storage.

According to another embodiment of the present disclosure, there is provided a non-transitory computer-readable storage medium having a program stored therein, the program causing a computer to function as a detector configured to detect position information related to a current position of a communication terminal apparatus, a determination part configured to determine whether a position indicated by the detected position information is within a set area, and a transmission controller configured to control a transmitter in a manner that, when the determination part determines that the position indicated by the position information is not within the set area, a control signal is transmitted to an information processing apparatus, the control signal issuing an instruction to erase at least data capable of identifying the user individually among a log of the user accumulated in the information processing apparatus.

According to one or more of embodiments of the present disclosure, the predetermined control can be performed such that, when the user leaves an area, it is made not possible to identify the log of the user during the stay in the area.

### BRIEF DESCRIPTION OF THE DRAWINGS

FIG. 1 is a diagram illustrating an overview of an erasure control system according to an embodiment of the present disclosure;

FIG. 2 is a block diagram showing a configuration of a management server according to a first embodiment;

FIG. 3 is a diagram showing an example of user logs stored in a log DB according to the first embodiment;

FIG. 4 is a flowchart showing erasure control processing according to the first embodiment;

FIG. 5 is a block diagram showing a main configuration of a user terminal according to a second embodiment;

FIG. 6 is a block diagram showing a main configuration of a management server according to the second embodiment;

FIG. 7 is a sequence diagram showing erasure control processing according to the second embodiment;

FIG. 8 is a diagram illustrating an overview of an erasure control system according to a third embodiment;

FIG. 9 is a block diagram showing a configuration of a vehicle according to the third embodiment; and

FIG. 10 is a flowchart showing operation processing of an erasure control system according to the third embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

1. Overview of erasure control system according to an embodiment of the present disclosure

2. First embodiment

3. Second embodiment

4. Third embodiment

5. Conclusion

### 1. OVERVIEW OF ERASURE CONTROL SYSTEM ACCORDING TO AN EMBODIMENT OF THE PRESENT DISCLOSURE

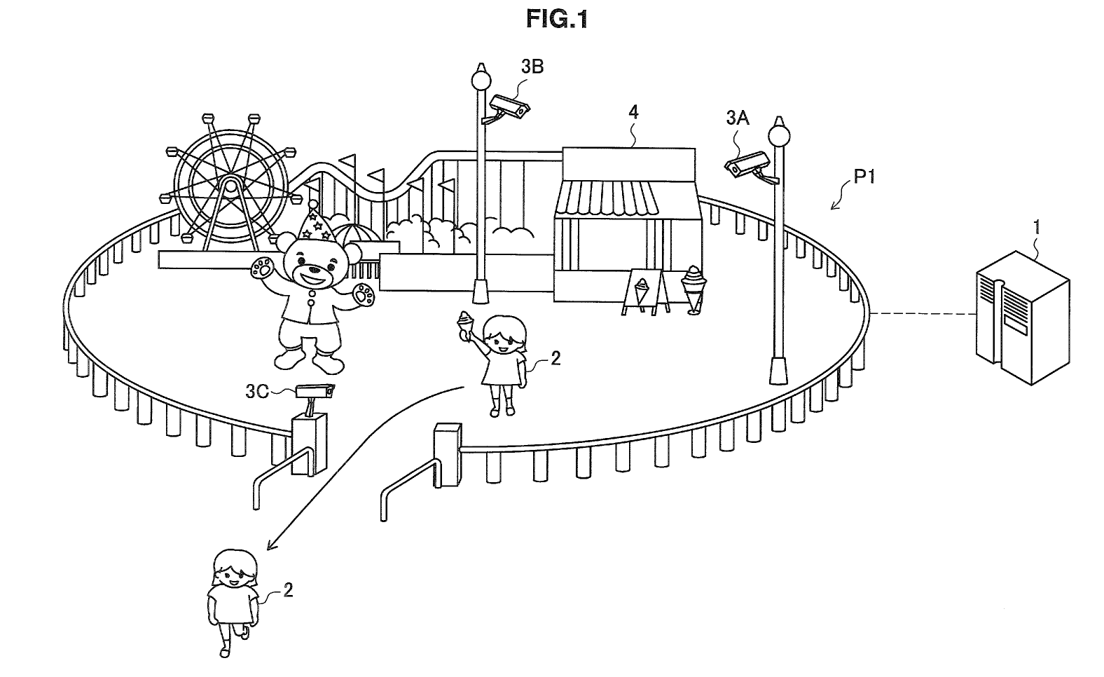

First, with reference to FIG. 1, an overview of an erasure control system according to an embodiment of the present disclosure will be described. FIG. 1 is a diagram illustrating an overview of an erasure control system according to an embodiment of the present disclosure. A control system according to the present embodiment is used in facilities such as a theme park, an amusement park, a baseball stadium, a department store, a shopping mall, a complex facility, an exhibition hall, an exhibition site, and an entertainment facility. The example shown in FIG. 1 shows the case where the control system according to the present embodiment is used in a theme park, for example.

A user in the theme park can receive various services such as photograph taking and offering of guidance information, and can also receive services that are personalized for the individual by additionally registering personal information in a management server 1. For example, the following service can be achieved: with the registration of a facial image of a user 2, a captured image in which the user 2 is shown is extracted by the management server 1 from captured images that are automatically taken by a camera 3A, 3B installed in the theme park, and provides the user 2 with the extracted captured image. Further, the following services can also be achieved: a service that generates and provides an image indicating a route which the user 2 has taken on a map of an area P1, based on an action history (history of position information) of the user 2; and a service that generates and provides an image obtained by arranging captured images each having the user 2 shown therein on a map based on the respective capturing locations.

Further, the following service can be achieved: with the accumulation of pieces of information on the attractions that the user 2 has ridden, an attraction that the user 2 has not ridden is shown, or an attraction that the user 2 likes is recommended based on the accumulated pieces of information. In addition, the following service can also be achieved: with the accumulation of pieces of information on products and foods that the user 2 has purchased from a shop 4, a product or food that the user likes is recommended based on the accumulated pieces of information, and a restaurant is shown to the user 2 at an estimated time at which the user 2 is hungry.

In this way, it is only during the user 2's stay in the specific area P1, that is, the theme park, that the user 2 can receive services that are personalized for the individual in the theme park by disclosing the user 2's own personal information to (/by registering the user 2's own personal information in) the theme park (management server 1). Further, it is only during the user 2's stay in the theme park that the user 2 can receive services using a nickname by registering his/her nickname as personal information for enjoying things that are completely different from his/her everyday life.

However, after leaving the specific area P1, that is, the theme park, the user 2 considers erasing the personal information disclosed to (/registered in) the theme park (management server 1), since the user 2 can no longer receive the services of the theme park. Alternatively, the user 2 considers erasing at least data capable of identifying the individual user accumulated in the theme park, the data being associated with a log, such as an action history, a purchase history, or an attraction history of the user.

Accordingly, a control system according to each embodiment of the present disclosure has been created in view of the circumstances described above. The control system according to each embodiment of the present disclosure performs control such that, when the user leaves a predetermined area, at least data capable of identifying the individual user among the log accumulated in the management server 1 is substantially erased, so that it is made not possible to identify the log of the user during his/her stay in the predetermined area.

In this way, after the user 2 has left the specific area P1, that is, the theme park, for example, the management server 1 which has managed the log of the user in the theme park erases the personal information of the user 2. Alternatively, management server 1 may erase data capable of identifying the individual user 2 (for example, facial image and name) among the log of the user 2, and hence, the user 2 no longer has a risk of being identified individually and the theme park can use pieces of log data as the data for analysis/statistics.

Further, in the case where the user 2 has registered a nickname different from his/her name, the management server 1 may perform control such that the nickname is erased. In this way, the user 2 no longer has a risk of letting other people know in everyday life the nickname that is set for the user 2 to enjoy things that are completely different from his/her everyday life.

Note that, as shown in FIG. 1, whether the user 2 has left the specific area P1, that is, the theme park, may be determined based on a facial image of a person leaving the theme park imaged by a camera 3C installed at an exit gate and the facial image of the user 2 that has been registered. Alternatively, the determination may be performed based on position information sent from a communication terminal apparatus (not shown) carried by the user 2.

Heretofore, an overview of a control system according to an embodiment of the present disclosure has been described. Next, a control system according to the present embodiment will be specifically described with reference to multiple embodiments.

### 2. FIRST EMBODIMENT

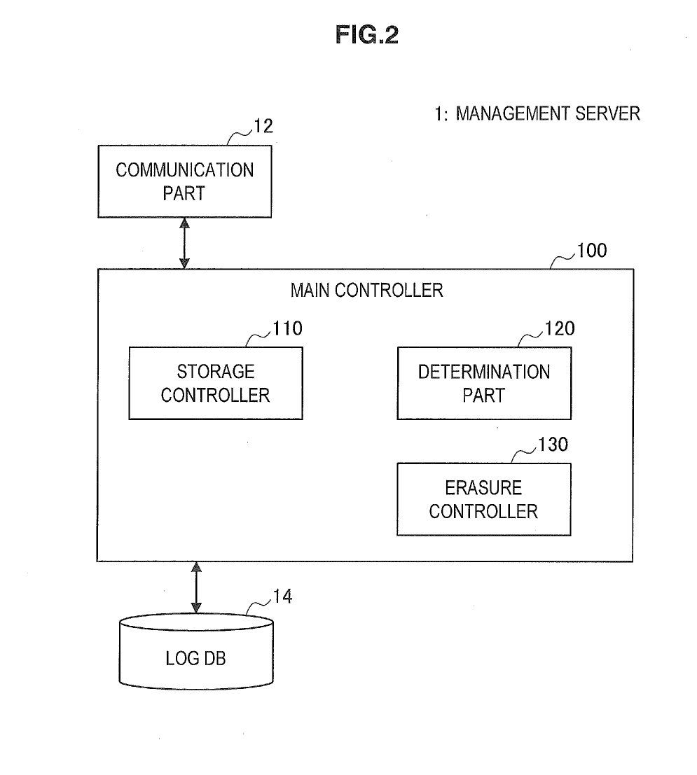

A control system according to a first embodiment performs control such that a management server 1 (information processing apparatus) shown in FIG. 1 accumulates a log in an area P1 of a user 2, and, in the case where the user 2 has left the area P1, erases the accumulated log. Hereinafter, with reference to FIGS. 2 to 4, a configuration and operation processing of the management server 1 according to the present embodiment will be described.

2-1. Configuration of Management Server>

FIG. 2 is a block diagram showing a configuration of the management server 1 according to the first embodiment. As shown in FIG. 2, the management server 1 includes a communication part 12, a main controller 100, and a log database (DB) 14.

(Communication Part 12)

The communication part 12 connects with an external device and is an interface that transmits and receives data. The communication part 12 according to the present embodiment connects with devices installed within the area P1, and transmits and receives data. Examples of the devices installed within the area P1 include cameras 3A to 3C shown in FIG. 1, a cash register in a shop 4 shown in FIG. 1, gates of respective attractions (not shown), a terminal apparatus installed within the area P1 for registering personal information (not shown). The communication part 12 receives captured images obtained by imaging inside the area P1 by the cameras 3A to 3C.

Here, the cameras 3A to 3C are each capable of transmitting a captured image (still image/moving image) obtained by imaging the user 2 to the management server 1. A method for the cameras 3A to 3C to identify and image the user 2 is not particularly limited. However, for example, the cameras 3A to 3C may each perform facial recognition on captured images based on a facial image of the user 2 that is registered in the management server 1 in advance, and identify a captured image including the user 2 in an angle of view. Further, the cameras 3A to 3C may each transmit, to the management server 1, a captured image taken in accordance with an identification signal (individual signal assigned to the user 2) sent from a wireless device (not shown) distributed to the user 2 by the theme park at the time of personal information-registration, in a state that the captured image is associated with the identification signal. In this way, the management server 1 can determine that a captured image, which is associated with an identification signal corresponding to the identification signal assigned to the user 2 at the time of the user 2's personal information-registration, is a captured image in which the user 2 is shown.

In addition, the management server 1 may perform facial recognition of captured images (still images/moving images) transmitted by the cameras 3A to 3C, and may identify a captured image including the user 2 in an angle of view.

Further, in the case where the cameras 3A to 3C each have a function of collecting sound (microphone), audio data obtained by collecting the voice of the user 2 (hereinafter, also referred to as recorded data) may be transmitted to the management server 1.

Further, the communication part 12 receives, from a cash register of the shop 4, a purchase history showing products and food/drink purchased by the user 2. The purchase history of the user 2 may be identified by acquiring a name, an identification signal, or a facial image of the user 2 at the time of selling, for example.

Further, the communication part 12 receives a riding history of the user 2 from a gate (not shown) of each attraction. The riding history of the user 2 may be identified by acquiring a name, an identification signal, or a facial image of the user 2 at the time of riding, for example.

Further, the communication part 12 receives personal information of the user 2 from a terminal apparatus for personal information-registration (not shown) installed within the area P1. The terminal apparatus for personal information-registration accepts input of the personal information of the user 2 through key input, pen input, touch input, or audio input. Example of the personal information of the user 2 includes data capable of identifying the individual user 2, such as a name, a nickname, or a facial image of the user 2. When entering the theme park, the user 2 inputs and registers personal information in the terminal apparatus for personal information-registration installed within the area P1, and thus can receive services specialized for the user 2 individually.

As described above, the communication part 12 connects with each device installed within the area P1, and can receive a history related to actions of the user 2 (log of user 2) at respective places (shop, attraction, gate, and the like). Note that the communication part 12 may receive the log of the user 2 collectively from a wireless device carried by the user 2. That is, in the case where there is a wireless device to be lent to the user 2 at the time of personal information-registration, the history related to actions of the user 2 at respective places is accumulated in the wireless device.

For example, when the user 2 walks near the camera 3A, the camera 3A receives a control signal sent automatically from a wireless device carried by the user 2, and a captured image taken by the camera 3A in accordance with the control signal is transmitted to the wireless device. In this way, captured images taken automatically in the vicinity are accumulated in the wireless device while the user 2 is walking within the area P1. Further, when the user 2 purchases a product or food/drink at the shop 4, a purchase history is input to the wireless device from the cash register of the shop 4. Further, when the user 2 rides on an attraction, a riding history is input to the wireless device from the gate of the attraction. Still further, the wireless device can accumulate, as an action history of the user 2, data such as pieces of position information acquired at regular intervals using sensors. Examples of the sensors include a global positioning system (GPS), an acceleration sensor, and a vibration sensor, which are mounted on the wireless device. In addition, in the case where the wireless device supports an electronic money system, the wireless device can accumulate pieces of electronic money settlement information as a purchase history. The wireless device transmits the accumulated log of the user 2 to the management server 1 at regular intervals or at a predetermined timing.

(Main Controller 100)

The main controller 100 controls each structural element of the management server 1. As shown in FIG. 2, the main controller 100 according to the present embodiment functions as a storage controller 110, a determination part 120, and an erasure controller 130.

The storage controller 110 performs control such that a log DB 14 stores a log of each user received from the communication part 12. Specifically, for example, the storage controller 110 associates at least one of a purchase history, an eating/drinking history, a captured image, and recorded data of the user 2 with data capable of identifying the individual user, and stores the associated data in the log DB 14 as the log of the user 2. The eating/drinking history may be extracted from the purchase history of food/drink. Further, the data capable of identifying the individual user includes a name, a facial image, or the like of the user. Those pieces of personal information are input from the terminal apparatus for personal information-registration installed within the area P1, and are transmitted to the management server 1. Otherwise, the pieces of personal information may be transmitted to the management server 1 through a network from a communication terminal apparatus, such as a cellular phone terminal, a smartphone, or a tablet terminal carried by the user 2.

Further, the storage controller 110 may cause the log DB 14 to store pieces of position information at which captured images are taken as the action history of the user 2 (information indicating a route that the user 2 has walked on). Alternatively, the storage controller 110 may also cause the log DB 14 to store pieces of position information transmitted from a wireless device lent to the user 2 as the action history of the user 2.

In this way, the storage controller 110 causes the log DB 14 to store the log of each user, and pieces of log data stored in the log DB 14 are used at the time of providing services to the user and at the time of visitor analysis/statistics.

The determination part 120 has a function of determining whether a position of a user is within a set area. For example, the determination part 120 determines whether the position of the user 2 shown in FIG. 1 is within the area P1.

Although the method of performing determination by the determination part 120 is not particularly limited, the determination may be performed, for example, by using the following methods.

For example, the determination part 120 analyzes a captured image taken near the boundary of the area P1, and can determine that the user 2 has left the area P1. Further, the determination part 120 refers to exit person-information (name, identification number, facial image, or the like of the exit person) acquired at an exit of the area P1, and can determine that the user 2 has left the area P1.

Further, the determination part 120 may also determine that the user 2 has left the area P1 based on position information sent by a communication terminal apparatus (cellular phone terminal, a smartphone, a tablet terminal, or the like) carried by the user 2. Specifically, in the case where a position indicated by the position information sent by the communication terminal apparatus carried by the user 2 is not within the set area P1, the determination part 120 can determine that the user 2 has left the area P1. In addition, the determination part 120 may also analyze intensity of radio waves transmitted from the communication terminal apparatus carried by the user 2 and may determine that the user 2 has left the area P1. Specifically, in the case where the intensity of radio waves transmitted from the communication terminal apparatus carried by the user 2 is less than a predetermined value, the determination part 120 can determine that the user 2 has left the area P1.

The erasure controller 130 substantially (logically) erases, when the determination part 120 determines that the position of the user is not within the area, at least data capable of identifying the individual user (for example, registered facial image) among the log of the user stored in the log DB 14. The substantial (logical) erasure may be, to be specific, that the erasure controller 130 limits the access to the data capable of identifying the individual user.

Further, when the determination part 120 determines that the user 2 has left the area P1, first, the erasure controller 130 makes it possible for an administrator to access the data capable of identifying the individual user, and, after an elapse of a certain period of time, makes it not possible for the administrator to access the data, and thus may substantially erase the data.

In this way, with the erasure of at least the data capable of identifying the individual user, since the association between the user and the log such as the action history is cancelled, the fear of the user that the individual user may be identified is eliminated, and the theme park can utilize the log as data for analysis/statistics.

Further, the erasure controller 130 may erase the data capable of identifying the individual user and the user log associated with the data. For example, the erasure controller 130 erases a facial image of the registered user, a captured image in which the user is shown, an action history, a purchase history, and the like. Further, the erasure controller 130 may also perform erasure by blurring only the face part of the user in a captured image in which the user is shown or by replacing the face part with another image.

In addition, the erasure controller 130 may also execute erasure of at least the data capable of identifying the individual user with a time factor or a distance factor taken into consideration. Accordingly, the erasure of data of a midway-exit person can be left pending. Specifically, for example, in the case where a certain time period has elapsed from when the position of the user 2 left the area P1, the erasure controller 130 performs control such that the erasure of data is executed. Further, in the case where the position of the user 2 has moved away a certain distance from the area P1, the erasure controller 130 may perform control such that the erasure of data is executed. The erasure controller 130 may estimate the distance between the position of the user 2 and the area P1 based on the time elapsed from when the user 2 left the area P1, or may detect the distance based on the position information indicating a current position of the user 2.

Another example in which a time factor is taken into consideration is as follows. The erasure controller 130 may perform control such that the erasure of data is executed, when the position of the user 2 has moved out of the area P1 and it is time after a predetermined time such as a closing time of the theme park.

Further, the erasure controller 130 may also perform control such that the erasure of data is executed, in the case where it is after a predetermined time associated with the user 2, for example, an end time of provision of a service specialized for the individual, or an expiration time of an admission ticket. In this way, for example, in the case where the user 2 has a ticket valid for 2 days admission to theme park, the erasure of the log of the user 2 is left pending even after the user 2 has left the area P1 of the theme park on the first day. Note that information of a predetermined time associated with the user 2 is stored in the log DB 14, for example.

(Log DB 14)

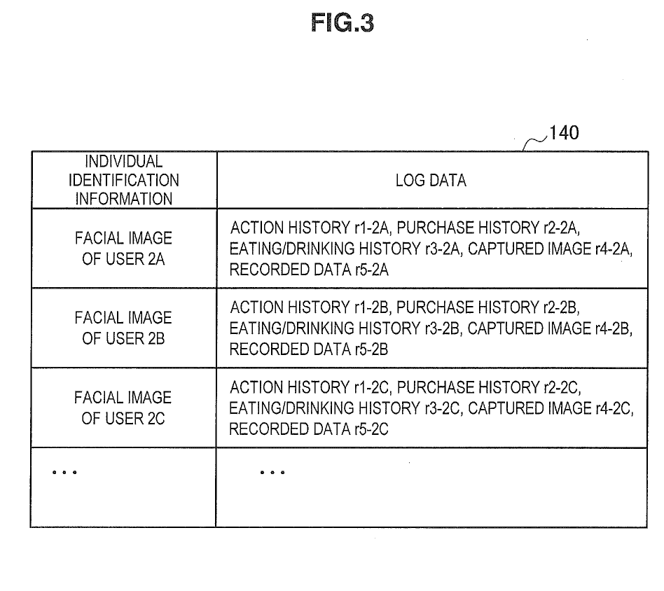

The log DB 14 is a storage storing a log of each user in association with data capable of identifying the user in accordance with control performed by the storage controller 110. Here, FIG. 3 shows an example of a user log 140 stored in the log DB 14.

As shown in FIG. 3, the user log 140 stores an action history r1, a purchase history r2, an eating/drinking history r3, a captured image r4, a recorded data r5, and the like, which are pieces of log data of a user, in association with data capable of identifying the user, such as a facial image.

Heretofore, a main configuration of the management server 1 according to the first embodiment has been described specifically. Note that the configuration of the management server 1 is not limited to the example shown in FIG. 2, and may further have a configuration for achieving service provision using a log of a user stored in the log DB 14, for example. Further, the management server 1 may also transfer a log of a user stored in the log DB 14 to another server (not shown) that achieves service provision using the log of the user.

<2-2. Operation Processing of Management Server>

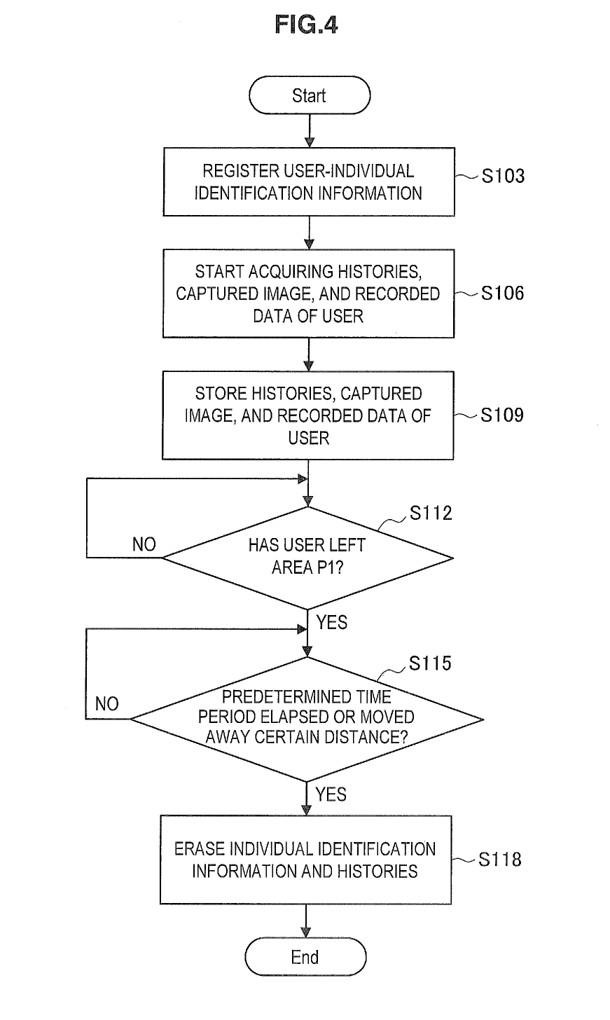

Next, with reference to FIG. 4, operation processing of the present embodiment will be described.

FIG. 4 is a flowchart showing erasure control processing according to the first embodiment. As shown in FIG. 4, first, in Step S103, the storage controller 110 of the management server 1 registers user-individual identification information (data capable of identifying the individual user).

Next, in Step S106, the management server 1 starts acquiring: various types of histories of a registered user, such as an action history, a purchase history, and an eating/drinking history; a captured image of the registered user; recorded data of the registered user; and the like. For example, the management server 1 transmits a facial image and an ID (identification signal) of the registered user to a camera 3 installed within the area P1.

Subsequently, in Step S109, the storage controller 110 of the management server 1 causes the log DB 14 to store the various types of histories, the captured image, and the like of each user acquired through the communication part 12 in association with data capable of identifying the individual user. The log of the user stored in the log DB 14 is used at the time of providing a service specialized for the individual user within the area P1.

Next, in Step S112, the determination part 120 of the management server 1 determines whether the position of the user 2 has left the area P1.

Subsequently, in the case where it is determined that the user 2 has left the area P1 (S112/Yes), in Step S115, the erasure controller 130 of the management server 1 determines whether a predetermined time period has elapsed since the user 2 left the area P1, or whether the user 2 has moved away a certain distance from the area P1.

Then, in the case where it is determined that the predetermined time period has elapsed since the user 2 left the area P1 or that the user 2 has moved away a certain distance from the area P1 (S115/Yes), the erasure controller 130 erases in Step S118 at least data capable of identifying the individual user among the log of the user accumulated in the log DB 14. Further, the erasure controller 130 may also erase data capable of identifying the individual user, various types of histories, captured images, and the like stored in the log DB 14.

Heretofore, erasure control processing of the first embodiment has been described specifically. Note that, in the flow shown in FIG. 4, the erasure controller 130 erases the data after a predetermined time period has elapsed since the user 2 left the area P1 or when the user 2 has moved away a certain distance from the area P1, but the execution of erasure according to the present embodiment is not limited thereto. For example, the erasure controller 130 according to the present embodiment may execute the erasure of data at substantially the same time as the time at which the user 2 leaves the area P1.

### 3. SECOND EMBODIMENT

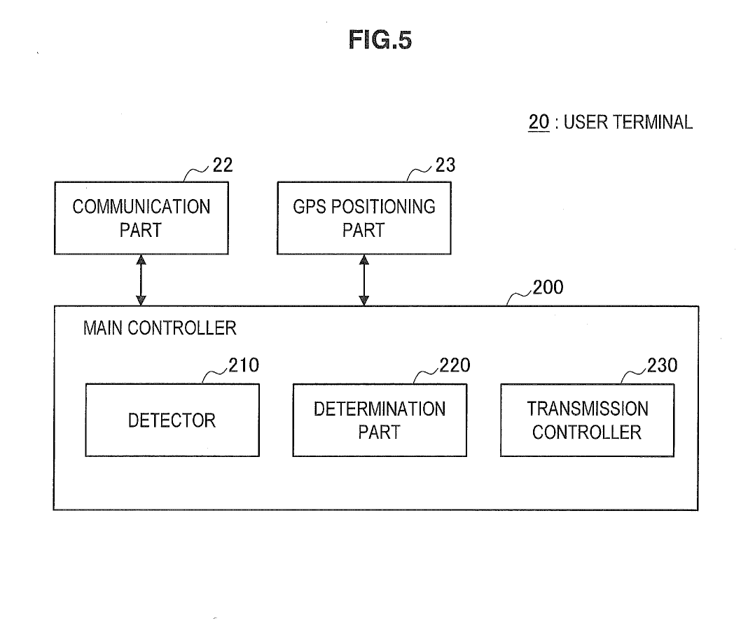

In the first embodiment described above, the management server 1 has the determination part 120 and the erasure controller 130, and performs centralized control of a log of each user, but a control system according to an embodiment of the present disclosure is not limited thereto. For example, a communication terminal apparatus carried by an individual user may be a control system configured to issue an instruction to erase a log of a user accumulated in a management server. Hereinafter, with reference to FIGS. 5 to 7, there will be described a control system in which the communication terminal apparatus (hereinafter, also referred to as user terminal) issues an instruction to erase a log.

<3-1. Configuration of User Terminal>

FIG. 5 is a block diagram showing a main configuration of a user terminal 20 according to a second embodiment. As shown in FIG. 5, the user terminal 20 includes a communication part 22, a GPS positioning part 23, and a main controller 200. Note that the user terminal 20 is achieved by a cellular phone terminal, a smartphone, a tablet terminal, a wearable device capable of acquiring a life log, or the like.

(Communication Part 22)

The communication part 22 connects with an external device and is an interface that transmits and receives data. For example, the communication part 22 connects with a network through a wireless LAN, Wi-Fi (registered trademark), infrared data communication, Bluetooth (registered trademark), or the like, and can transmit and receive data to and from a management server 10.

Further, the communication part 22 according to the present embodiment transmits position information related to a current position of the user terminal 20 detected by a detector 210 to be described later to the management server 10 at regular intervals or at a predetermined timing. Further, the communication part 22 transmits a control signal issuing an instruction to erase data in accordance with control performed by a transmission controller 230 to be described later to the management server 10.

(GPS Positioning Part 23)

The global positioning system (GPS) positioning part 23 receives radio waves from GPS satellites, and measures a position (current position) at which the user terminal 20 is present. Note that the GPS positioning part 23 is an example of a position information acquisition part configured to acquire current position information of the user terminal 20 based on signals acquired from outside, and an example of the position information acquisition part according to the present embodiment is not limited thereto. For example, the position information acquisition part may acquire the current position information through Wi-Fi, transmission/reception with another cellular phone, a PHS, a smartphone, or the like, or near field communication.

(Main Controller 200)

The main controller 200 controls each structural element of the user terminal 20. As shown in FIG. 5, the main controller 200 of the present embodiment functions as the detector 210, a determination part 220, and the transmission controller 230.

The detector 210 detects position information related to a current position of the user terminal 20. For example, the detector 210 may detect position information (latitude, longitude, and altitude) measured by the GPS positioning part 23 as the position information related to the current position. Further, the detector 210 may automatically image the surroundings with a camera (not shown) installed in the user terminal 20, and may detect the position information related to the current position based on the captured image, or may detect the position information based on information that is manually input by a user. Further, the detector 210 may also detect position information related to the current position (at least information indicating that the position information is located outside the area P1) based on an exit signal that is sent in the vicinity of the area P1 or at an exit gate.

The detector 210 outputs the detected position information to the determination part 220.

The determination part 220 determines whether a position indicated by the position information detected by the detector 210 is within a set area, that is, determines whether the user has left the set area. For example, the determination part 220 determines whether the user 2 has left the area P1 based on the position information (latitude, longitude, and altitude) measured by the GPS positioning part 23. Further, the determination part 220 outputs the determination results to the transmission controller 230.

In the case where the determination part 220 determines that the position indicated by the detected position information is not within the set area, that is, the user has left the set area, the transmission controller 230 performs control such that a control signal issuing an instruction to erase data is transmitted from the communication part 22 to the management server 1. Specifically, among the log of the user accumulated in the management server 1, the transmission controller 230 transmits a control signal issuing an instruction to substantially (logically) erase at least data capable of identifying the individual user to the management server 10.

Further, the transmission controller 230 according to the present embodiment may execute the transmission of the control signal issuing an instruction to erase data with a time factor or a distance factor taken into consideration. Accordingly, the transmission of the control signal issuing an instruction to erase data can be left pending in the case where a user exits midway. Specifically, for example, in the case where a certain time period has elapsed from when the position of the user 2 left the area P1, the transmission controller 230 performs control such that the transmission of the control signal issuing an instruction to erase data is executed. Further, in the case where the position of the user 2 has moved away a certain distance from the area P1, the transmission controller 230 may perform control such that the transmission of the control signal issuing an instruction to erase data is executed.

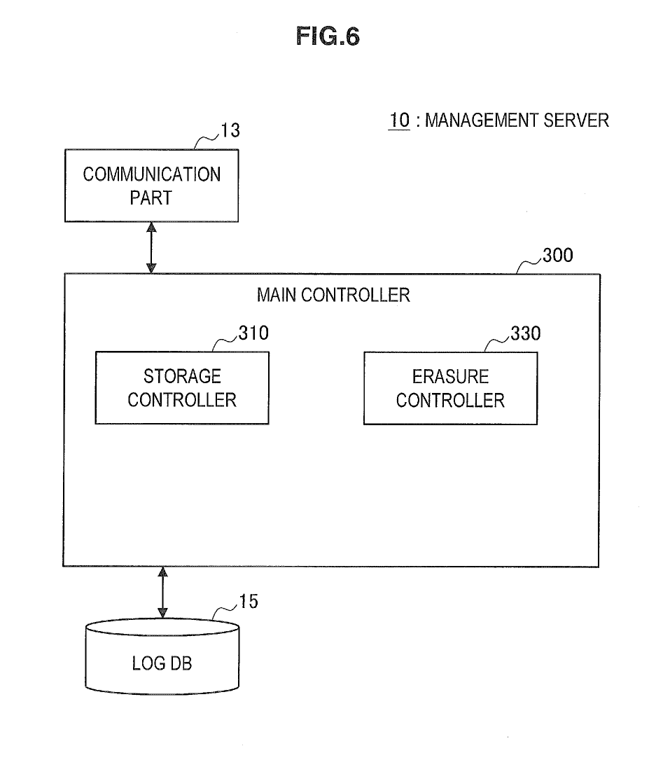

Heretofore, a main configuration of the user terminal 20 according to the present embodiment has been described. Next, with reference to FIG. 6, a configuration of the management server 10 according to the present embodiment will be described.

<3-2. Configuration of Management Server>

FIG. 6 is a block diagram showing a main configuration of a management server 10 according to the second embodiment. As shown in FIG. 6, the management server 10 includes a communication part 13, a log DB 14, and a main controller 300. The management server 10 according to the present embodiment accumulates a log of the user 2 in the area P1, and performs control of erasing the accumulated log in accordance with a control signal issuing an instruction to erase data transmitted from a user terminal 20 carried by the user 2.

(Communication Part 13)

The communication part 13 connects with an external device and is an interface that transmits and receives data. In the same manner as the communication part 12 of the management server 1 according to the first embodiment, the communication part 13 according to the present embodiment connects with each device installed within the area P1, and transmits and receives data. Examples of the devices installed within the area P1 include cameras 3A to 3C shown in FIG. 1, a cash register in a shop 4 shown in FIG. 1, gates of respective attractions (not shown), a terminal apparatus for registering personal information installed within the area P1 (not shown).

Specifically, the communication part 13 receives captured images obtained by imaging within the area P1 by the cameras 3A to 3C, receives, from a cash register of the shop 4, a purchase history showing products and food/drink purchased by the user 2, and receives a riding history of the user 2 from a gate (not shown) of each attraction. Further, the communication part 13 may receive personal information of the user 2 from a terminal apparatus for personal information-registration (not shown) installed within the area P1, and may also receive personal information of the user 2 from the user terminal 20.

In addition, the communication part 13 according to the present embodiment receives a control signal issuing an instruction to erase log data from the user terminal 20.

(Main Controller 300)

The main controller 300 controls each structural element of the management server 1. As shown in FIG. 6, the main controller 300 according to the present embodiment functions as a storage controller 310 and an erasure controller 330.

The storage controller 310 performs control such that a log DB 15 stores a log of each user received from the communication part 13. Specifically, for example, in the same manner as the storage controller 110 according to the first embodiment, the storage controller 310 associates at least one of a purchase history, an eating/drinking history, a captured image, and recorded data of the user 2 with data capable of identifying the individual user, and stores the associated data in the log DB 15 as the log of the user 2. The pieces of log data stored in the log DB 15 are used at the time of providing services to the users and at the time of visitor analysis/statistics.

In the same manner as the erasure controller 130 according to the first embodiment, the erasure controller 330 substantially (logically) erases at least data capable of identifying the individual user among the log of the user stored in the log DB 15, in accordance with the control signal issuing an instruction to erase log data received by the communication part 13 from the user terminal 20.

(Log DB 15)

The log DB 15 is a storage storing, in the same manner as the log DB 14 according to the first embodiment, a log of each user in association with data capable of identifying the user in accordance with control performed by the storage controller 310. Specifically, the log DB 15 stores an action history, a purchase history, an eating/drinking history, a captured image, a recorded data, and the like, which are pieces of log data of a user, in association with data capable of identifying the user, such as a facial image.

Heretofore, a main configuration of the management server 10 according to the present embodiment has been described specifically.

<3-3. Operation Processing>

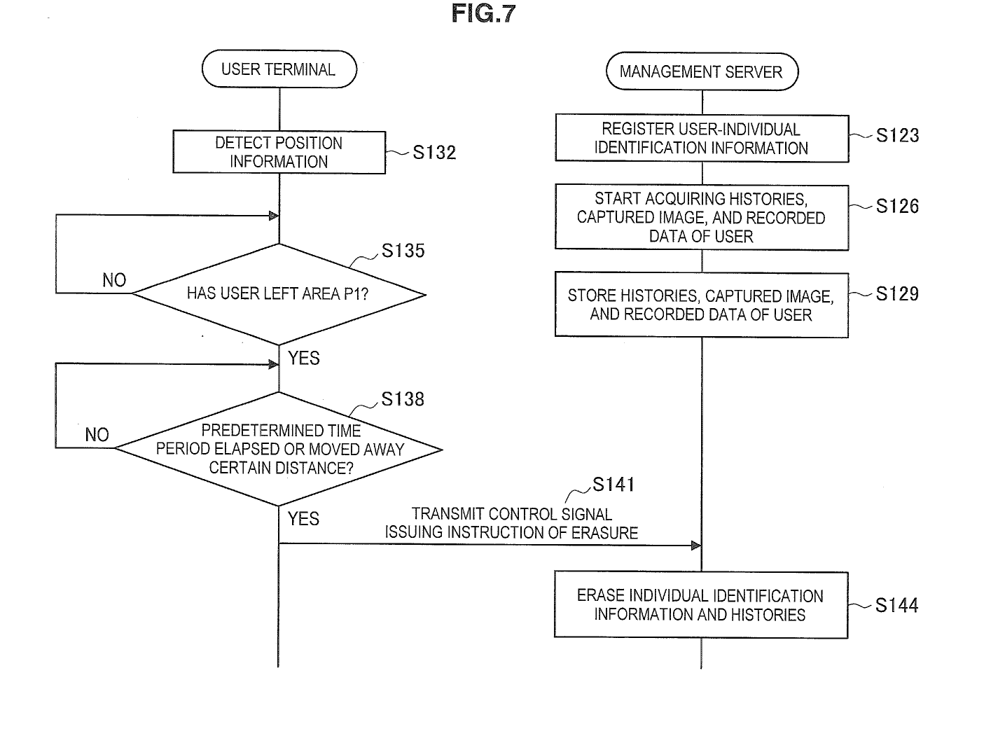

Next, with reference to FIG. 7, operation processing according to the present embodiment will be described. FIG. 7 is a sequence diagram showing erasure control processing according to the second embodiment.

As shown in FIG. 7, first, in Step S123, the storage controller 310 of the management server 10 registers user 2-individual identification information (data capable of identifying the individual user). The management server 10 may receive the user 2-individual identification information from the user terminal 20, or from a terminal apparatus used for a predetermined registration installed within the area P1.

Next, in Step S126, the management server 10 starts acquiring: various types of histories, such as an action history, a purchase history, and an eating/drinking history of a registered user; a captured image of the registered user; recorded data of the registered user; and the like.

Subsequently, in Step S129, the storage controller 310 of the management server 10 causes the log DB 15 to store the various types of histories, the captured image, and the like of each user acquired through the communication part 13 in association with data capable of identifying the individual user. The log of the user stored in the log DB 15 is used at the time of providing a service specialized for the individual user within the area P1.

On the other hand, in Step S132, the detector 210 of the user terminal 20 carried by the user 2 detects position information indicating a current position at regular intervals or at a predetermined timing.

Next, in Step S135, the determination part 220 of the user terminal 20 determines whether the user 2 has left the area P1 based on the position information detected by the detector 210.

Subsequently, in the case where it is determined that the user 2 has left the area P1 (S135/Yes), the transmission controller 230 of the user terminal 20 determines in Step S138 whether a predetermined time period has elapsed since the user 2 left the area P1, or whether the user 2 has moved away a certain distance from the area P1.

Then, in the case where it is determined that the predetermined time period has elapsed since the user 2 left the area P1 or that the user 2 has moved away a certain distance from the area P1 (S135/Yes), the transmission controller 230 transmits in Step S141, to the management server 10, a control signal issuing an instruction to erase at least data capable of identifying the individual user among the log of the user stored in the management server 10.

In Step S144, the erasure controller 330 of the management server 10 erases at least data capable of identifying the individual user among the log of the user stored in the log DB 15 in accordance with the control signal issuing an instruction to erase data transmitted from the user terminal 20. Further, in the case where the control signal is for issuing an instruction to erase data capable of identifying the individual user, various types of histories, the captured image, and the like, the erasure controller 330 erases the data capable of identifying the individual user, various types of histories, the captured image, and the like, which are stored in the log DB 15.

Heretofore, erasure control processing according to the second embodiment has been described specifically. Note that, in the flow shown in FIG. 7, the erasure controller 330 erases the data after a predetermined time period has elapsed since the user 2 left the area P1 or when the user 2 has moved away a certain distance from the area P1, but the execution of erasure according to the present embodiment is not limited thereto. For example, the erasure controller 330 according to the present embodiment may execute the erasure of data at substantially the same time as the time at which the user 2 leaves the area P1.

### 4. THIRD EMBODIMENT

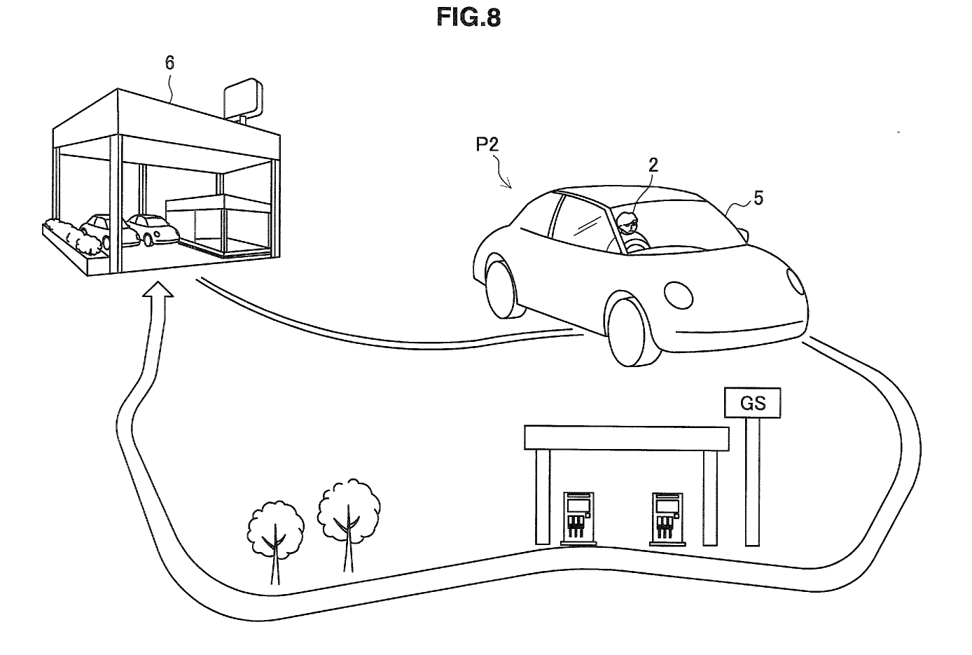

In each of the embodiments described above, the description has been made of the log-erasure control system in the case where the log of the user 2 during the user 2's stay within the area P1 of a facility typified by a theme park is stored in the management server 1, 10 (information processing apparatus). However, the erasure control to which the erasure control system according to an embodiment of the present disclosure is applied is not limited to the area of a facility, and the system may be a control system of erasing a log of the user 2 in the case where the log obtained while the user 2 is within a moving object is stored, for example. Hereinafter, with reference to FIGS. 8 to 10, there will be described erasure control of a log of the user 2, the log being stored while the user 2 is within a vehicle 5 serving as an example of the moving object.

<4-1. Overview>

FIG. 8 is a diagram illustrating an overview of an erasure control system according to a third embodiment. As shown in FIG. 8, when the user 2 rent the vehicle 5 (information processing apparatus) from a car rental shop 6 and drives on the vehicle 5, a driving history during a rental period is stored as a log of the user in the vehicle 5. Further, in the case where the vehicle 5 can connect with a network, the user 2 can download and purchase music, movies, and the like, and can enjoy listening to and watching them. Such purchase histories may also be stored as the log of the user in the vehicle 5. Further, the vehicle 5 can also store, as the log of the user, a captured image obtained by imaging scenery of outside by an exterior camera mounted on the vehicle 5.

In this way, the user 2 can confirm a travel route, confirm a purchase list of music and movies, and can enjoy video of the scenery of outside by playing back the video that has been shot. Further, a name, a nickname, a facial image, or the like is registered as information capable of identifying the individual user, and thus, communication can be performed with another communicable vehicle. On the other hand, the car rental shop 6 can utilize the log of the user such as the driving history and the purchase history as data for analysis/statistics.

However, in the case where the log of the user is stored in association with the personal information (facial image, name, and the like) of the user, it is not desirable for the user that the vehicle 5 continues holding the log of the user even after the end of the rental period.

Accordingly, the erasure control system according to the present embodiment performs control such that the log of the user stored in the vehicle 5 is erased when the user 2 has left an area P2 of the vehicle 5, and also by taking into consideration the rental period or the like. Hereinafter, a configuration and operation processing of the vehicle 5 according to the third embodiment will be described sequentially.

<4-2. Configuration of Vehicle>

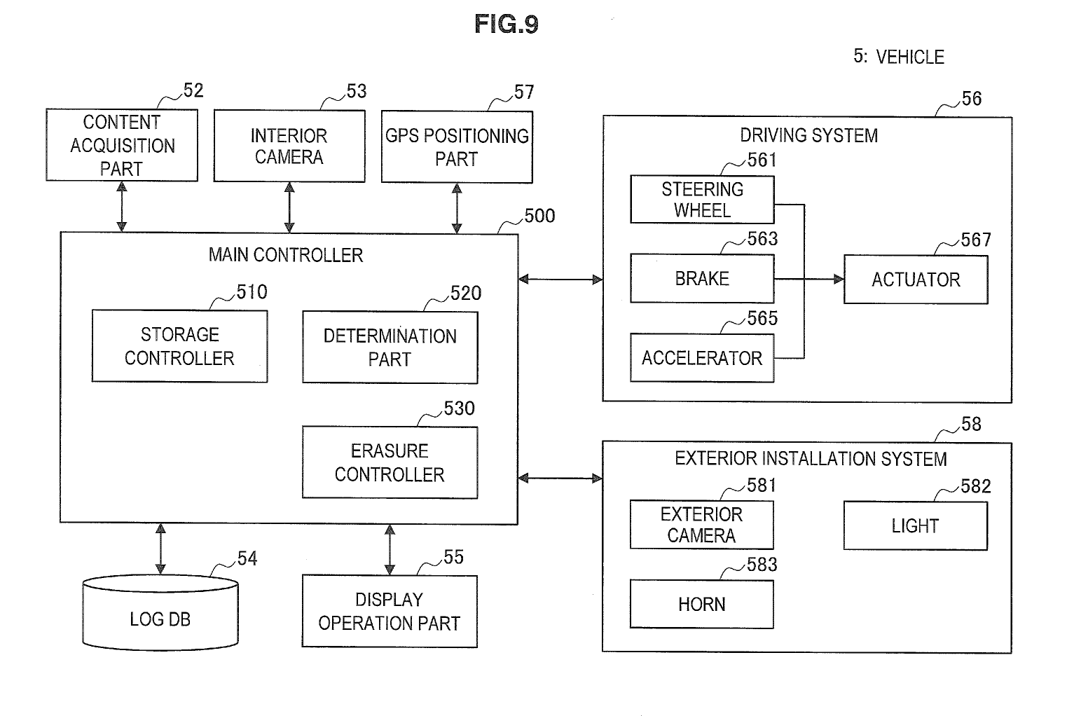

FIG. 9 is a block diagram showing a configuration of the vehicle 5 according to the third embodiment. As shown in FIG. 9, the vehicle 5 includes a main controller 500, a content acquisition part 52, an interior camera 53, a log DB 54, a display operation part 55, a driving system 56, a GPS positioning part 57, and an exterior installation system 58.

(Main Controller 500)

The main controller 500 controls each structural element of the vehicle 5. As shown in FIG. 9, the main controller 500 according to the present embodiment functions as a storage controller 510, a determination part 520, and an erasure controller 530.

The storage controller 510 performs control such that the log DB 54 stores a log of the user 2 obtained while the user 2 is on the vehicle 5. Specifically, for example, the storage controller 510 causes the log DB 54 to store, as a log of the user 2, a driving history indicating a travel route of the vehicle 5 driven in accordance with operation of the user 2. The driving history is generated based on position information of the vehicle 5 acquired from the GPS positioning part 57 at regular intervals or at a predetermined timing.

Further, in the case where the content acquisition part 52 downloads and purchases content such as music and movies from a network, the storage controller 510 causes the log DB 54 to store the purchase history as a log of the user 2. In addition, the storage controller 510 may also cause the log DB 54 to store a history of an amount of gasoline supplied to the vehicle 5 or an amount of electricity with which the vehicle 5 is charged, as a log of the user 2.

Note that the storage controller 510 causes the log DB 54 to store those logs in association with data capable of identifying the individual user. Examples of the data capable of identifying the individual user are the name and the facial image of the user 2.

The determination part 520 determines whether a position of the user 2 is within the area P2 of the vehicle 5, that is, whether the user 2 has left the vehicle 5. For example, the determination part 520 compares a facial image of a person in the vehicle 5 captured by the interior camera 53 with a facial image of the user 2 that has been registered in advance, and determines whether the user 2 has left the area P2 (vehicle 5). Further, the determination part 520 may also determine whether there is a person in the vehicle (within the area P2) by using a human sensor (not shown).

Note that, since it can be assumed that, after the user 2 arrives at a destination and leaves the area P2 (vehicle 5), the user 2 comes back in the area P2 again in returning home, the determination part 520 may determine that the user 2 has left the vehicle 5 when a predetermined time period (half a day to one day) has elapsed since the user 2 left the area P2. Alternatively, the determination part 520 may determine that the user 2 has left the vehicle 5 when the user 2 has left the area P2 and a rental period registered in advance has elapsed or completion of payment of the rental car fee has been confirmed.

In the case where the determination part 520 determines that the position of the user 2 is not within the area P2, that is, that the user 2 has left the area P2, the erasure controller 530 substantially (logically) erases at least data capable of identifying the individual user among the log of the user stored in the log DB 54. Accordingly, since the log of the user 2 acquired while the user 2 is within the area P2 (vehicle 5) is erased at the time when the user 2 leaves the area P2, the log of the user 2 is no longer held after return of the rental car (vehicle 5). Further, with the erasure of at least data capable of identifying the individual user, since the association between the user and the log such as the purchase history is cancelled, the fear of the user that the individual user may be identified is eliminated, and the theme park can utilize the log as data for analysis/statistics.

(Content Acquisition Part 52)

The content acquisition part 52 can connect with a network and can download content such as music and movies from a predetermined server on the network. The downloaded music and movies are played back through a speaker (not shown) and a display part (display operation part 55, window display) inside the vehicle.

(Interior Camera 53)

The interior camera 53 images a person in the vehicle 5 and outputs the captured image to the main controller 500. The captured image taken by the interior camera 53 is used when the determination part 520 determines whether the user 2 is present inside the vehicle. Note that a human sensor instead of the interior camera 53 may be installed in the vehicle.

(Log DB 54)

The log DB 54 is a storage storing, in accordance with the control performed by the storage controller 510, a driving history, a purchase history, a captured image taken by an exterior camera 581, and the like as a log of the user in association with data capable of identifying the individual user. Specifically, the log DB 54 stores a driving history, a purchase history, a captured image, and the like, which are the log of the user 2, in association with a facial image or a name of the user 2.

(Display Operation Part 55)

The display operation part 55 is a device having a display function and operation input function, and is disposed at a place where a user is capable of performing operation from the driver's seat inside the vehicle, for example. The display operation part 55 may be achieved with a touch panel display. The user 2 operates the display operation part 55 to perform the following: registration of personal information; operation of purchasing desired content; operation of playing back music or a movie; input of destination in the case where the vehicle 5 has a navigation system; and the like. Further, the case is assumed in which an administrator inputs the fact that payment of the fee for the vehicle 5 serving as a rental car is completed to the display operation part 55.

(GPS Positioning Part 57)

The global positioning system (GPS) positioning part 57 receives radio waves from GPS satellites, and measures a position (current position) at which the vehicle 5 is present. Note that the GPS positioning part 57 is an example of a position information acquisition part configured to acquire current position information of the vehicle 5 based on signals acquired from outside, and an example of the position information acquisition part according to the present embodiment is not limited thereto. For example, the position information acquisition part may acquire position information from surrounding base stations through wireless communication.

(Driving System 56)

The driving system 56 includes a configuration necessary for the vehicle 5 to drive. Specifically, as shown in FIG. 9, the driving system 56 includes a steering wheel 561, a brake 563, an accelerator 565, and an actuator 567. The steering wheel 561, the brake 563, and the accelerator 565 are placed at the driver's seat, and accept operation of the driver. The actuator 567 is a tire, an engine, or the like, and is driven based on operation information from the steering wheel 561, the brake 563, and the accelerator 565.

(Exterior Installation System 58)

The exterior installation system 58 includes a configuration mounted outside the vehicle 5. Specifically, as shown in FIG. 9, the exterior installation system 58 includes an exterior camera 581, a light 582, and a horn 583. The exterior camera 581 has a function of imaging scenery of outside the vehicle. Note that the exterior camera 581 may be mounted such that outside of the vehicle is imaged from inside the vehicle. The light 582 is an illumination part provided to each of the front and the back of the vehicle 5 such that light is emitted on each of the travelling direction (ahead) of the vehicle 5 and the back of the vehicle 5. The horn 583 is an output part configured to output warning sounds to the surroundings in response to operation performed by the user 2, and is normally provided at a front part of the vehicle 5.

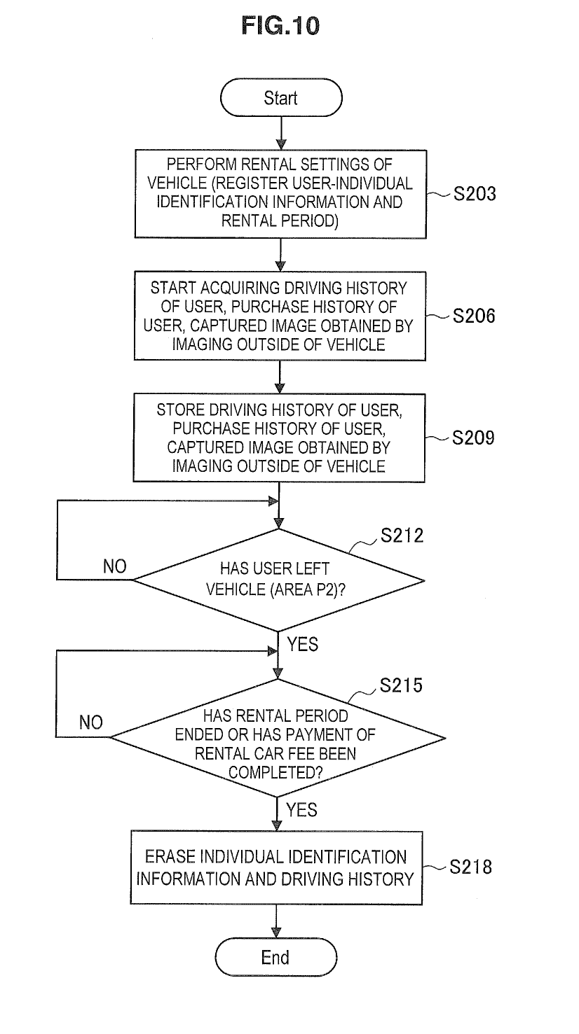

Heretofore, a configuration of the vehicle 5 (information processing apparatus) according to the present embodiment has been described specifically. Subsequently, operation processing of the vehicle 5 according to the present embodiment will be described with reference to FIG. 10.

<4-3. Operation Processing>

FIG. 10 is a flowchart showing operation processing of an erasure control system according to the third embodiment. As shown in FIG. 10, first, in Step S203, the vehicle 5 performs rental settings. Specifically, for example, the vehicle 5 accepts a setting of a rental period and registration of user-individual identification information from the display operation part 55, for example.

Next, in Step S206, the vehicle 5 starts acquiring a driving history, a purchase history, a captured image obtained by imaging outside of the vehicle taken by the exterior camera 581, or the like as a log of the registered user (user 2).

Subsequently, in Step S209, the storage controller 510 of the vehicle 5 causes the log DB 54 to store the acquired log of the user in association with data capable of identifying the individual user. The storage controller 510 causes the log DB 54 to store the following as the log of the user, for example: a purchase history based on content acquired by the content acquisition part 52; a captured image obtained by imaging outside of the vehicle taken by the exterior camera 581; a driving history based on information acquired by the GPS positioning part 57 or the driving system 56; or the like. The log of the user stored in the log DB 54 may be utilized when the user 2 confirms his/her driving history or purchase history or when the user 2 enjoy playing back the captured image of outside of the vehicle.

Next, in Step S212, the determination part 520 of the vehicle 5 determines whether the position of the user 2 has left the area P2 (vehicle 5).

Subsequently, in the case where it is determined that the position of the user 2 has left the area P2 (S212/Yes), the erasure controller 530 of the vehicle 5 determines in Step S215 whether or not a rental period has ended or payment of the rental car fee has been completed.

Then, in the case where it is determined that a rental period has completed or payment of the rental car fee has been completed (S215/Yes), the erasure controller 530 erases in Step S218 at least data capable of identifying the individual user among the log of the user stored in the log DB 54. Alternatively, the erasure controller 530 may erase data capable of identifying the individual user, various types of histories, captured images, and the like stored in the log DB 54.

Heretofore, erasure control processing according to the third embodiment has been described specifically. As described above, the erasure control system according to an embodiment of the present disclosure can be applied to, in addition to the erasure control with respect to a log of a user who is present inside the area P1 of a facility typified by a theme park, the erasure control with respect to a log of a user who is present inside the area P2 of a moving object typified by a vehicle.

### 5. CONCLUSION

As described above, according to the erasure control system of the present embodiment, at least data capable of identifying the individual user among the log of the user can be substantially erased, so that the log of the user during the user's stay within a predetermined area is not identified when the user has left the predetermined area.

It should be understood by those skilled in the art that various modifications, combinations, sub-combinations and alterations may occur depending on design requirements and other factors insofar as they are within the scope of the appended claims or the equivalents thereof.

For example, it is also possible to create a computer program for causing hardware such as CPU, ROM, and RAM, which are built in the information processing apparatus (management server 1, 10, vehicle 5) or the user terminal 20, to exhibit substantially the same functions as those of respective structures of the information processing apparatus or the user terminal 20 described above. Further, there is also provided a storage medium having the computer program stored therein.

Further, the information processing apparatus (management server 1, 10, vehicle 5) according to an embodiment of the present disclosure may notify a user of erasure completion when the erasure of the log of the user is completed.

Additionally, the present technology may also be configured as below.

(1) An information processing apparatus including:

a storage controller configured to perform control in a manner that a log of a user is stored in a storage;

a determination part configured to determine whether a position of the user is within a set area; and

an erasure controller configured to substantially erase, when the determination part determines that the position of the user is not within the set area, at least data capable of identifying the user individually among the log of the user stored in the storage.

(2) The information processing apparatus according to (1),

wherein the erasure controller executes the erasure of the data with a time factor or a distance factor taken into consideration.

(3) The information processing apparatus according to (2),

wherein the erasure controller executes the erasure in a case where it is detected that a certain time period has elapsed since the position of the user left the set area, or it is detected that the position of the user has moved away a certain distance from the set area.

(4) The information processing apparatus according to any one of (1) to (3),

wherein the erasure controller substantially erases the data by limiting access to the data.

(5) The information processing apparatus according to (4),

wherein, when the determination part determines that the position is not within the set area, the erasure controller performs control in a manner that the data capable of identifying the individual user is accessible to an administrator, and, after an elapse of a certain period of time, performs control in a manner that the data is not accessible to the administrator.

(6) The information processing apparatus according to any one of (1) to (5),

wherein the determination part determines whether it is after a predetermined time associated with the user, and

wherein, in a case where the determination part determines that it is after the predetermined time, the erasure controller substantially erases the data capable of identifying the individual user.

(7) The information processing apparatus according to any one of (1) to (6),

wherein the data capable of identifying the individual user is a facial image of the user.

(8) The information processing apparatus according to any one of (1) to (7),

wherein the determination part determines whether the position of the user is within the set area based on position information acquired from a communication terminal apparatus carried by the user.

(9) The information processing apparatus according to any one of (1) to (7),

wherein the determination part analyzes intensity of radio waves transmitted from a communication terminal apparatus carried by the user, and determines whether the position of the user is within the set area.

(10) The information processing apparatus according to any one of (1) to (7),

wherein the determination part analyzes a captured image taken near a boundary of the set area, and determines whether the position of the user is within the set area.

(11) The information processing apparatus according to any one of (1) to (7),

wherein the determination part refers to exit person-information acquired at an exit of the set area, and determines whether the position of the user is within the set area.

(12) The information processing apparatus according to any one of (1) to (11),

wherein the storage controller performs control in a manner that the storage stores, as the log of the user, at least one of an action history, a purchase history, an eating/drinking history, captured image data, and recorded data of the user during stay of the user within the set area, in association with the data capable of identifying the individual user.

(13) A communication terminal apparatus including:

a detector configured to detect position information related to a current position of a communication terminal apparatus;

a determination part configured to determine whether a position indicated by the detected position information is within a set area; and

a transmission controller configured to control a transmitter in a manner that, when the determination part determines that the position indicated by the position information is not within the set area, a control signal is transmitted to an information processing apparatus, the control signal issuing an instruction to erase at least data capable of identifying a user individually among a log of the user accumulated in the information processing apparatus.

(14) The communication terminal apparatus according to (13),

wherein the transmission controller executes the transmission of the control signal issuing an instruction to erase data with a time factor or a distance factor taken into consideration.

(15) The communication terminal apparatus according to (14),

wherein the transmission controller executes the transmission of the control signal in a case where it is detected that a certain time period has elapsed since the position indicated by the position information left the set area, or it is detected that the position indicated by the position information has moved away a certain distance from the set area.

(16) An information processing apparatus including:

a storage controller configured to perform control in a manner that a log of a user is stored in a storage;

a receiver configured to receive a control signal issuing an instruction to erase at least data capable of identifying the user individually among the log of the user, the control signal being transmitted from a communication terminal apparatus because a position of the communication terminal apparatus is determined not within a set area; and

an erasure controller configured to substantially erase the data capable of identifying the individual user among the log of the user stored in the storage in accordance with the received control signal.

(17) A non-transitory computer-readable storage medium having a program stored therein, the program causing a computer to function as

a storage controller configured to perform control in a manner that a log of a user is stored in a storage,

a determination part configured to determine whether a position of the user is within a set area, and

an erasure controller configured to substantially erase, when the determination part determines that the position of the user is not within the set area, at least data capable of identifying the user individually among the log of the user stored in the storage.

(18) A non-transitory computer-readable storage medium having a program stored therein, the program causing a computer to function as

a detector configured to detect position information related to a current position of a communication terminal apparatus;

a determination part configured to determine whether a position indicated by the detected position information is within a set area; and

a transmission controller configured to control a transmitter in a manner that, when the determination part determines that the position indicated by the position information is not within the set area, a control signal is transmitted to an information processing apparatus, the control signal issuing an instruction to erase at least data capable of identifying the user individually among a log of the user accumulated in the information processing apparatus.

What is claimed is:

1. An information processing apparatus comprising:
a storage controller configured to perform control in a manner that a log of a user is stored in a storage;
a determination part configured to determine whether a position of the user is within a set area; and
an erasure controller configured to substantially erase, when the determination part determines that the position of the user is not within the set area, at least data capable of identifying the user individually among the log of the user stored in the storage.

2. The information processing apparatus according to claim 1,
wherein the erasure controller executes the erasure of the data with a time factor or a distance factor taken into consideration.

3. The information processing apparatus according to claim 2,
wherein the erasure controller executes the erasure in a case where it is detected that a certain time period has elapsed since the position of the user left the set area, or it is detected that the position of the user has moved away a certain distance from the set area.

4. The information processing apparatus according to claim 1,
wherein the erasure controller substantially erases the data by limiting access to the data.

5. The information processing apparatus according to claim 4,
wherein, when the determination part determines that the position is not within the set area, the erasure controller performs control in a manner that the data capable of identifying the individual user is accessible to an administrator, and, after an elapse of a certain period of time, performs control in a manner that the data is not accessible to the administrator.

6. The information processing apparatus according to claim 1,
wherein the determination part determines whether it is after a predetermined time associated with the user, and
wherein, in a case where the determination part determines that it is after the predetermined time, the erasure controller substantially erases the data capable of identifying the individual user.

7. The information processing apparatus according to claim 1,
wherein the data capable of identifying the individual user is a facial image of the user.

8. The information processing apparatus according to claim 1,
wherein the determination part determines whether the position of the user is within the set area based on position information acquired from a communication terminal apparatus carried by the user.

9. The information processing apparatus according to claim 1,
wherein the determination part analyzes intensity of radio waves transmitted from a communication terminal apparatus carried by the user, and determines whether the position of the user is within the set area.

10. The information processing apparatus according to claim 1,
wherein the determination part analyzes a captured image taken near a boundary of the set area, and determines whether the position of the user is within the set area.

11. The information processing apparatus according to claim 1,
wherein the determination part refers to exit person-information acquired at an exit of the set area, and determines whether the position of the user is within the set area.

12. The information processing apparatus according to claim 1,
wherein the storage controller performs control in a manner that the storage stores, as the log of the user, at least one of an action history, a purchase history, an eating/drinking history, captured image data, and recorded data of the user during stay of the user within the set area, in association with the data capable of identifying the individual user.

13. A communication terminal apparatus comprising:
a detector configured to detect position information related to a current position of a communication terminal apparatus;
a determination part configured to determine whether a position indicated by the detected position information is within a set area; and
a transmission controller configured to control a transmitter in a manner that, when the determination part determines that the position indicated by the position information is not within the set area, a control signal is transmitted to an information processing apparatus, the control signal issuing an instruction to erase at least data capable of identifying a user individually among a log of the user accumulated in the information processing apparatus.

14. The communication terminal apparatus according to claim 13,
wherein the transmission controller executes the transmission of the control signal issuing an instruction to erase data with a time factor or a distance factor taken into consideration.

15. The communication terminal apparatus according to claim 14,
wherein the transmission controller executes the transmission of the control signal in a case where it is detected that a certain time period has elapsed since the position indicated by the position information left the set area, or it is detected that the position indicated by the position information has moved away a certain distance from the set area.

16. An information processing apparatus comprising:
a storage controller configured to perform control in a manner that a log of a user is stored in a storage;
a receiver configured to receive a control signal issuing an instruction to erase at least data capable of identifying the user individually among the log of the user, the control signal being transmitted from a communication terminal apparatus because a position of the communication terminal apparatus is determined not within a set area; and
an erasure controller configured to substantially erase the data capable of identifying the individual user among the log of the user stored in the storage in accordance with the received control signal.

17. A non-transitory computer-readable storage medium having a program stored therein, the program causing a computer to function as
a storage controller configured to perform control in a manner that a log of a user is stored in a storage,
a determination part configured to determine whether a position of the user is within a set area, and
an erasure controller configured to substantially erase, when the determination part determines that the position of the user is not within the set area, at least data capable of identifying the user individually among the log of the user stored in the storage.

18. A non-transitory computer-readable storage medium having a program stored therein, the program causing a computer to function as
a detector configured to detect position information related to a current position of a communication terminal apparatus;
a determination part configured to determine whether a position indicated by the detected position information is within a set area; and
a transmission controller configured to control a transmitter in a manner that, when the determination part determines that the position indicated by the position information is not within the set area, a control signal is transmitted to an information processing apparatus, the control signal issuing an instruction to erase at least data capable of identifying the user individually among a log of the user accumulated in the information processing apparatus.
